(19) United States
(12) Patent Application Publication
(10) Pub. No.: US 2012/0193382 A1
(43) Pub. Date: Aug. 2, 2012

(54) HYDRATION SYSTEM

(76) Inventor: Nathan Andrew Wilson, Woodstock, GA (US)

(21) Appl. No.: 13/017,100

(22) Filed: Jan. 31, 2011

(51) Int. Cl. B62J 11/00

(52) U.S. Cl. 224/414

(57) ABSTRACT

The present invention relates to hydration systems, and more particularly to hydration systems that can be attached to the top-tube and down-tube frame members of bicycles so that the bicycle riders do not need to wear the hydration systems on their back when they are riding on bicycles. The mouth piece held around the center of handlebar is in front of riders' face providing easy liquid access to the bikers. The bicycle riders can take off the present invention from the bicycle and wear the present invention on their back when they are not riding on the bicycle. The present invention comprises at least one liquid bottle inside a waterproof fabric pack that can carry a large amount of liquid. In addition to being a hydration system this product provides additional storage for the rider to carry bike tools, snacks, etc.

### BACKGROUND OF THE INVENTION

1. Field of the Invention

The present invention relates to hydration systems, and more particularly to hydration systems that can be attached to bicycle frames for use by cyclists during cycling and can be taken off and worn by cyclists on their back when they are not riding on bicycles.

2. Description of Related Art

It is very important for the bike riders to stay hydrated while biking. There are different types of bicycle riders, road cyclists, mountain bikers, commuter cyclists, touring cyclists, recreational cyclists, and race bikers. Normally the demand for carrying a large quantity of liquid is not critical for commuter cyclists or race bikers because the distance for the former may be within an hour; for the latter, the liquid may be supplied by the team car. On the contrary, road cyclists or mountain bikers normally need to carry a large quantity of liquid because they normally bike for long distances and are not able to refill liquid in the wild or on the road. However, even thought the demand for carrying a large quantity of liquid is not high for commuters or racers, to be able to carry a large amount of liquid is important to the health and safety of all kinds of riders no matter whether they are riding recreationally, commuting, training, or racing.

There are at least three ways to carry liquid known to the bicycle riders. First, and the most traditional way is to have a cage on the frame (down-tube or seat tube) of a bike to carry a liquid bottle. Secondly, the biker may wear a fanny-sack with bottle mounts to carry a liquid bottle. Thirdly, the bikers carry liquid reservoir (or a bottle) in a backpack and drink liquid through a tube.

There are pros and cons each way. The disadvantage of the 1^{st} and traditional way is that when the cyclists reach for the bottle to drink, the normal riding posture can be disturbed, the balance and control can be impaired. Furthermore, the liquid bottle cage limits the number and the size of liquid bottles that can fit on the bike and often riders drop their liquid bottles when trying to put them back in the bottle cage. Therefore there is a need for a device that can provide liquid to cyclists on the move without interrupting their riding posture and can carry different size and numbers of bottles. For the 2^{nd} and the 3^{rd}, liquid adds extra weight to the bikers, which exhausts bikers unnecessarily and restricts bikers' mobility. When the situation lasts for a while, the riders start to feel tension and pain. Some packs even hinder a rider's performance or cause muscle cramps and body pains. Therefore, there is a need in the cycling community to have the ability to carry more liquid without placing strain on their bodies.

To overcome the aforementioned hydration problems encountered by cyclists various attempts have been made as exemplified by U.S. Pat. Nos. 4,095,812; 4,274,566; 4,911,339; 5,115,952; 5,301,858; 6,401,997; 6,953,135; and 7,631,784. However, most of these inventions need to mount additional hardware such as brackets, cages, or wires on bicycles for carrying liquid bottles or containers; such additions frequently leave marks on the frames of bicycles. To fit into the brackets or cages or wires, particular shapes or sizes of liquid bottles or containers are required; thus, the flexibility and versatility of liquid bottles or containers are restricted.

Some inventions do not need brackets or cages or wires to help carry liquid on bicycle. For example, U.S. Pat. No. 5,024,358 to Reichert et al. discloses a narrow bottle that snaps onto the top and down tubes of the bicycle frame. The liquid bottle is rigid and is in triangular shape to adapt to the geometry of bikes. U.S. Pat. No. 5,788,134 to Matic, Jr. also discloses a rigid, triangular shaped liquid container that attaches to the down tube and seat tube frame members. Like Reichert '358, the Matic '134 also employs a rigid container, which is not well-suited to accommodate differences in bicycle frame geometry. In addition, the flexibility and versatility of liquid containers are restricted.

U.S. Pat. No. 5,358,142 to Holmes shows a mouth-pressurized drinking bag for cyclists. The system comprises a collapsible bladder and an elastic enclosure that surrounds the bladder. The drawback of this invention is that there is no means of restraining the sides of the bag. As the bag is pressurized, it will expand outward like a balloon. The expansion of the bag will cause the rider's legs to rub against the sides of the bag, thus interfering with the rider's pedaling motion.

U.S. PreGrant Publication No. US 2010/0059565 to Cote shows a container mounted onto a bicycle's top-tube member using fastening means that do not leave a mark on the frame members of a bicycle to deliver liquid to cyclists. This system addresses some of the needs of cyclists, but it does not offer alternative for backpacking when cyclists are not riding on a bike or additional storage space for other necessary items that cyclists will carry.

Therefore, there's a need for a hydration system that can be attached to the bike without leaving permanent mark and allow the flexibility to adapt to a large variety of bicycles and liquid bottles. There are also necessary items that all bike riders should carry with them while on a bike. These items include, but are not limited to, cell phone, identification, spare tube, patch kit, and multi-tool. Therefore, there is also a need to allow riders to carry these necessary items easily without having to add additional storage on their bikes. When the bike riders stop riding on a bike and start to hike, they also need to carry liquid with them. Therefore, there is a need for a hydration system that allows for the rider to take it off from the bicycle and wear it on their back when not riding.

### SUMMARY OF THE INVENTION

The primary object of the present invention is to allow the bicycle rider to stay hydrated while eliminating unnecessary weight on the biker's body.

Another important object of the present invention is to allow for carrying a large quantity of liquid so that the cyclists can stay hydrated when biking for a long distance.

Another object of the present invention is to allow the bicycle rider stay hydrated without interrupting normal riding position.

Another object of the present invention is to allow the bicycle rider stay hydrated without restricting biker's mobility.

Another object of the present invention is to provide versatility so that the bike riders can wear it on their back when they choose to; for example, when they are not riding on the bike.

Another object of the present invention is to provide flexibility to accommodate differences in bicycle frame geometry.

Another object of the present invention is to provide room for storing necessary items that bike riders should carry with them while they are riding on a bike.

Yet another object of the present invention is simple and easy to be manufactured at a low production cost.

The present invention, a hydration system, comprises (1) a waterproof pack having at least one waterproof zippers; (2) at least one liquid bottle having a drinking tube removably attached to the liquid bottle, may be via a tube portal, and a mouth piece removably attached to the drinking tube, may be via a connector; (3) at least one pocket for holding said liquid bottles; (4) several pairs of straps attached to the inside of the pack; and (5) several pairs of straps attached to the outside of the pack. The port assembly and the connector assembly may include a shut-off or check valve, which is capable of closing to maintain liquid within the liquid bottle or the tube, respectively. The configuration and construction of liquid bottle, drinking tube, mouth piece, portal valves, and check valves are known technologies in the art.

The pack is made of lightweight waterproof fabric so that no extra weight is added to the cyclists when they wear the pack on their back while they are not riding on the bike. Waterproof material such as is commonly used in waterproof backpacks and sports bags including, but not limited to, nylon or canvas may be used. The pack and zipper are waterproof so that the pack can be used in all kinds of weather conditions. In a preferred embodiment, the pack is in a triangle shape such that it can snuggly fit into the space between the top-tube and down-tube frame members of the bicycle. However the pack may vary in shapes and sizes to accommodate differences in bicycle frame geometry. Also, the material of the pack is not rigid, it can adapt to slight differences in bicycle frame geometry without even change the shape or the size. Inside of the pack, there may be at least one pocket or compartment for holding liquid bottles or other necessary items that bike riders carry when they are riding on a bike. The pocket may further comprise a thermal insulation material inside to keep liquid from getting hot or cold due to the weather.

The hydration system is attached to both top-tube and down-tube frame members of the bike by at least four pairs of straps sewn on the outside of the pack. The straps having a durable fastening means at one end, engage with each other, to form a loop around the top-tube and down-tube frame members such that the pack is securely attached to the bike's frame. In one of embodiment, the durable fastening means is a Bungee hook and loop system; other fastening means known in the art including fabric hook and loop fasteners such as Velcro™ may be used. The weight of liquid is carried by the bike, so a large quantity of liquid can be carried without putting additional weight and stress on the cyclists. The present invention can keep cyclists stay hydrated without restricting cyclists' mobility.

The present invention further comprises two pairs of straps for allowing the bikers to wear the pack on their back when they are not riding on a bike. The straps are preferably sewn on the inside of the pack but they may be on the outside of the pack. The present invention may further comprise other pairs of straps to fasten the pack to the chest or waist of cyclists. The present invention may also comprise a pair of straps inside to compress the pack itself while it is not fully loaded.

Inside the pack of one embodiment, there is a pocket with fastening means used for holding the liquid bottle. Liquid is carried in the liquid bottle in the pack and delivered through a drinking tube and a mouth piece, which extend upward from the liquid bottle, through the opening of the pack, and reaches to the place near the center of handlebar in front of the cyclists so that the cyclists can easily access the mouth piece and drink without interrupting cycling posture. A couple of clips or loops can be used to keep the drinking tube and mouth piece in place. The liquid bottle is constructed out of multilayer of polyethylene or polyurethane; other suitable materials known in the art may be used. The drinking tube is constructed out of polyethylene or polyurethane; other materials known in the art may be used. The drinking tube has a first end and a second end; the first end is removably attached to the mouth piece, may be via a connector; the second end is threaded and is removably attached to the tube portal (internally threaded) at the top of the liquid bottle. Silicone is a commonly used material for a mouth piece; other suitable materials may be used. Other embodiment of mouth piece may twist on and off or has an on/off switch to prevent leakage. The present invention provides flexibility to accommodate liquid bottles that are manufactured by other vendors. The pack may be sold alone for customers who already have liquid bottles that can fit in the pocket of the pack.

A cyclist or bike rider must stay hydrated while riding. The present invention allows for a large quantity of liquid to be carried without the possibility of losing the liquid while riding. Also, because it uses the strength of the bike frame to carry the hydration system, the cyclists no longer need to carry unnecessary weight. Even though the hydration system is connected to the bike while riding, the versatility of the present invention allows for the rider to take it off and by pulling out the two hidden straps the rider can now wear it on their back when not riding. The present invention is unique compared to other inventions because it allows the rider an alternative to having a saddle bag to carry their essential riding needs. No other hydration system has the same versatility as the present invention.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of an embodiment in a closed position according to the present invention.

FIG. 2 is a top view of an embodiment in an opened position according to the present invention.

FIG. 3 is a side view of an embodiment of the invention attached to the top tube and down tube frame members of a bicycle.

FIG. 4 shows a cyclist wearing an embodiment of the invention when the cyclist is not riding on a bicycle.

### DESCRIPTION OF THE PREFERRED EMBODIMENT

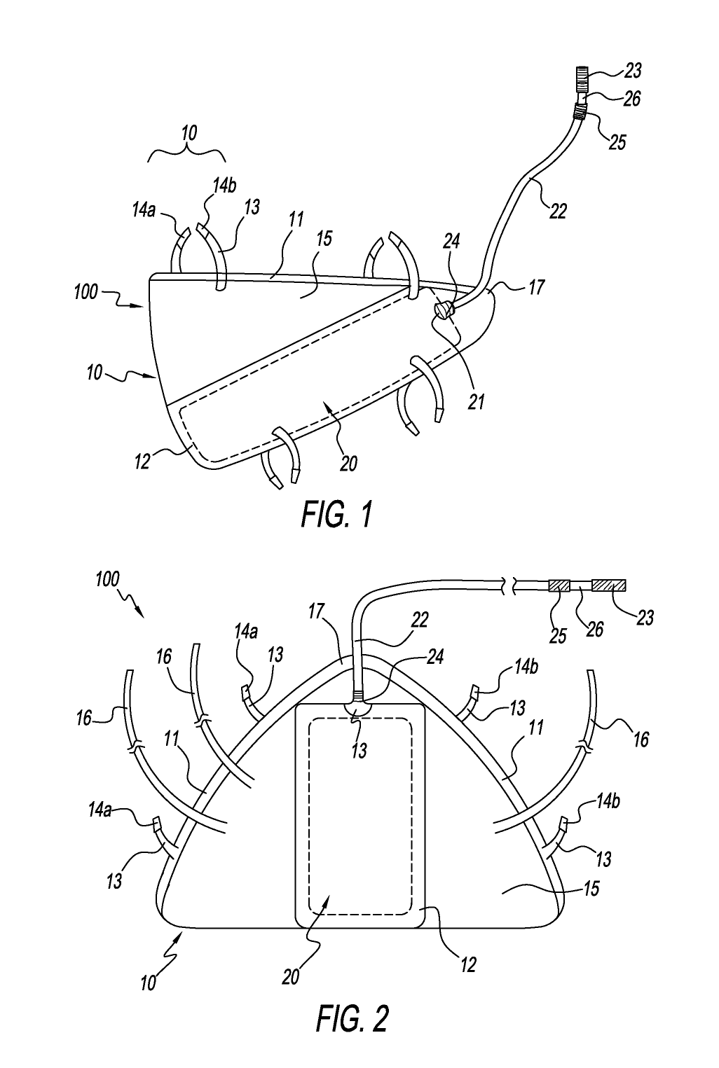

Referring to FIGS. 1 and 2, there are disclosed a hydration system 100 in a closed and open position, comprising a pack 10 having at least one waterproof zipper 11, at least one pocket 12 inside the pack 10 for holding liquid bottles 20, at least four pairs of straps 13 on the outside of the pack 10, a liquid bottle 20 with a tube portal 21, a drinking tube 22, and a mouth piece 23. The pack 10 is constructed of lightweight waterproof fabric such as is commonly used in waterproof backpacks and sports bags including, but not limited to, nylon and canvas. The pocket 12 for holding the liquid bottle 20 may be made of the same material as for the pack 10; it may further comprise thermal insulation material inside to keep liquid from the heat or the cold. The waterproof zippers may be on the inside or outside of the pack. In the preferred embodiment, one zipper closes from the rear end to the front end of the sack 10, and a small opening 17 remains at the front of the sack 10 to let the hose 22 exit from the pack.

The hose 22 has a first end and a second end; the first threaded end 24 is removably attached to the internally threaded tube portal 21 at top of the liquid bottle 20; the second threaded end 25 is removably attached to the mouth piece 23, may be via a connector 26. The drinking tube 22 extends from the port 21 of liquid bottle 20 and exits from the opening 17 of the pack 10. In the preferred embodiment, the liquid bottle 20 is constructed out of multilayer of polyethylene; other suitable materials known in the art including polyurethane may be used. The hose 22 is made of polyethylene; other materials known in the art including polyurethane may be used. The port assembly and the connector assembly may include a shut-off or check valve, which is capable of closing to maintain liquid within the liquid bottle or the drinking tube, respectively. Silicone is a commonly used material for mouth piece 23; other suitable materials may be used. Modest tooth pressure is sufficient to get liquid flowing. Other embodiment of mouth piece 23 may be twisted or switched on and off to prevent leakage. The configuration and construction of liquid bottle, drinking tube, mouth piece, portal valves, and check valves are known technologies in the art.

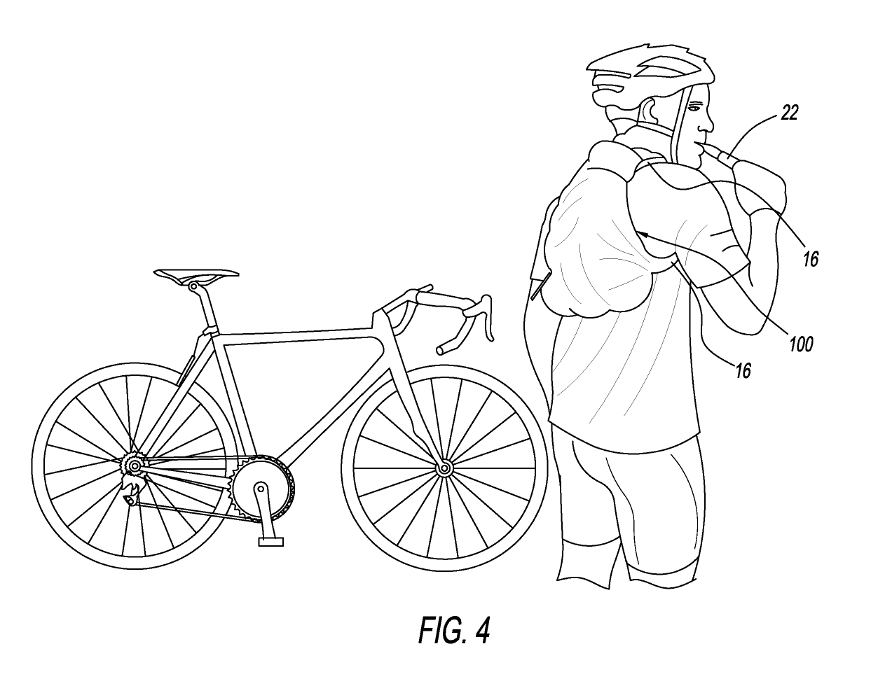

In the preferred embodiment, the four pairs of straps 13 sewn on the outside of the pack 10 have durable fastening means 14. For each pair of straps 13, one strap has a durable fastening hook 14a at the end; the other has a durable fastening loop 14b at the end; when the two ends engaged with each other they form a loop around the top-tube 31 or down-tube 32 of a bicycle 30 so that the hydration system 100 is securely mounted on the bicycle (see FIG. 4). In the preferred embodiment, the durable fastening means 14 is a Bungee hook and loop system; other fastening means known in the art including fabric hook and loop fasteners such as Velcro™ may be used. The pocket 12 for holding the liquid bottle 20 may have a closure or a fastening means to tightly hold the liquid bottle 20 in places so that the weight of liquid is balanced on the bike. The empty space 15 above the pocket 12 allows the riders to put the necessary items that all bike riders should carry with them while on a bike which include cell phone, identification cards, spare tube, patch kit, and multi-tool. Inside of the pack 10 there may be more pockets or stripes (not shown in FIG. 1 or 2) with fastening means to securely hold items in places.

The pack 10 further comprises two pairs of straps 16 (not shown in FIG. 1) that are used to allow cyclists to wear on their back. In the preferred embodiment, the stripes 16 are sewn on the inside of the pack 10 and are made of fabric such as is commonly used in the waterproof backpacks and sports bags. When the cyclists are not riding on the bicycle, they can take the hydration system 100 off the bike 30 and pull out the two pairs of hidden straps 16 and wear hydration system 100 on their back. When they want to ride on the bike they can simply tuck the stripes 16 back inside the pack 10 and mount the hydration system 100 back on the bicycle 30. The straps 16 may be sewn on the outside of the pack 10 for the same purpose described earlier.

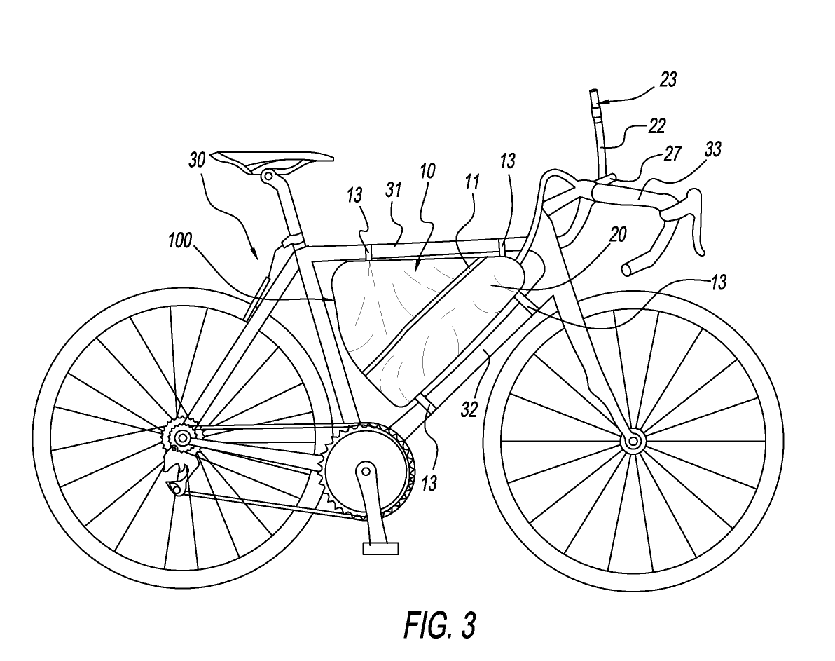

FIG. 3 shows a hydration system 100 mounted on a bike 30 via four pairs of straps; two pairs of straps 13 form two loops surrounding the top-tube 31 frame member of the bike 30, and another two pairs of straps 13 form another two loops surrounding the down-tube 32 frame member of the bike 30. The hydration system 100 snuggly and securely fit into the space between the top-tube 31 and down-tube 32 frame members of the bicycle 30. The drinking tube 22 extends upward from the port 21 of the liquid bottle 20 through the opening of the pack 10 and reaches to the place near the center of handlebar 33 in front of riders' face; thus, the cyclists can easily access the mouth piece 23 and drink while biking without compromise the cycling posture. A couple of clips or loops 24 can be used to keep the drinking tube 22 and mouth piece 23 in place. The pack 10 of the hydration system 100 is preferably in a triangle shape; other shapes that are different from the one shown in the drawings may be used.

The hydration system 100 may be worn by riders on their back when they are not riding on a bicycle. FIG. 4 shows a rider wearing the hydration system 100 on his back via straps 16 that are commonly used for backpack.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A hydration system that is attached to the bicycle, comprises (1) a pack having waterproof zippers; (2) a liquid bottle having a drinking tube and a mouth piece; (3) a pocket for holding said liquid bottle; (4) a plurality of straps in pairs on the outside of said pack, said straps having fastening means at ends are used to loop around the top-tube and down-tube frame members of said bicycle such that the hydration system is securely attached to said bicycle; and (5) a plurality of straps in pairs for allowing cyclists to wear said hydration system on their back.

2. A hydration system that is attached to the bicycle, comprises (1) a pack having at least one waterproof zippers; (2) at least one liquid bottle having a drinking tube and a mouth piece; (3) at least one pocket for holding said liquid bottle; (4) a plurality of straps in pairs on the outside of said pack, said straps having fastening means at ends are used to loop around the top-tube and down-tube frame members of said bicycle such that the hydration system is securely attached to said bicycle; and (5) a plurality of straps in pairs for allowing cyclists to wear said hydration system on their back.

3. The hydration system of claim 2, wherein said pack is made of waterproof fabric.

4. The hydration system of claim 2, wherein said fastening means are fabric hook and loop fastening means.

5. The hydration system of claim 2, wherein said fastening means are Bungee hook and loop.

6. The hydration system of claim 2, wherein said fastening means are fabric hook and loop fastening means.

7. The hydration system of claim 2, wherein said straps for allowing cyclists to wear said hydration system on their back are sewn on the inside of the pack.

8. The hydration system of claim 2, wherein said liquid bottle is made of polyethylene.

9. The hydration system of claim 2, wherein said drinking tube is made of polyethylene.

10. The hydration system of claim 2, wherein said mouth piece is made of silicon.

11. The hydration system of claim 2, wherein said pack may be of different shapes, preferably of a triangle shape.

12. The hydration system of claim 2, wherein the liquid bottle may be of different sizes and shapes.

13. The hydration system of claim 2 further has mechanisms to prevent from leakage.

14. The hydration system of claim 13, wherein the mechanisms include check valves.

15. The hydration system of claim 2 further has fastening means to hold said drinking tube and said mouth piece in place; said fastening means include hook, loop and snap on.

16. The hydration system of claim 1 has more than one zippers, liquid bottles and pockets.

17. The hydration system of claim 2 further has a connector to allow said drinking tube to removably connect with said mouth piece.

18. The hydration system of claim 2, wherein said liquid bottle further has an internally threaded tube portal to removably connect with said drinking tube.

19. The hydration system of claim 2, wherein said pack further has means to securely hold said liquid bottle and necessary items in place including fabric fastening means, pockets, and closure.

20. The hydration system of claim 2, wherein said pocket further has thermal insulation material inside the pocket.
